(19) United States
(12) Patent Application Publication
(10) Pub. No.: US 2003/0087677 A1
(43) Pub. Date: May 8, 2003

(54) Self-powered wireless communication device and method of use

(76) Inventors: Edward Miller, Fairfax, VA (US); Donald O'Connor, Arlington, VA (US); Joseph King, Silver Spring, MD (US)

Correspondence Address: Clarkl & Brody, Suite 600, 1750 K Street, NW, Washington, DC, 20006, US

(21) Appl. No.: 10/271,578

(22) Filed: Oct. 17, 2002

Related U.S. Application Data
(60) Provisional application No. 60/329,760, filed on Oct. 18, 2001.
(60) Provisional application No. 60/331,009, filed on Nov. 6, 2001.

(51) Int. Cl. H04M 1/00; H04B 1/38

(52) U.S. Cl. 455/572; 455/573

(57) ABSTRACT

A power generating mechanism having a movable element is mounted to a wireless communication device. Movement of the movable element generates electricity via the power generating mechanism to allow a user to make a phone call when a battery of the device is discharged. The power generating mechanism can be a mechanical type or a piezoelectric type, and can involve a keypad, a battery cover, an antenna, a crank, or keypad cover. The wireless device can also include an auxiliary power source and a switch to active the auxiliary power source when needed, and a light adapted to illuminate when a call is being received.

This application claims priority under 35 USC 119(e) based on provisional patent application Nos. 60/329,760 filed on Oct. 18, 2001, and 60/331,009 filed on Nov. 6, 2001.

### FIELD OF THE INVENTION

The present invention is directed to self-powered wireless communication device and, in particular, to a wireless communication device having a power generating mechanism that enables at least one call to be made from the device should the device battery be discharged.

### BACKGROUND ART

In the prior art, battery powered wireless communication devices (cell phones) are well known. In general, these devices include a power source such as a rechargeable battery that provides power to transmit and receive signals for device operation.

One inherent problem with these types of devices is that the batteries discharge over time, and the device is useless as a communication tool without power. This problem can be particularly troublesome if the device user is in an emergency situation, and cannot use the wireless device because the battery is dead.

The invention solves this problem by providing the capability to make a phone call even though the battery is dead.

The use of self-powering mechanisms in a variety of devices is known. For example, U.S. Pat. No. 5,838,138 to Henty discloses the use of a mechanism in combination with a laptop keyboard wherein tapping of the keyboard keys helps power the laptop. Other self-powered devices include radios such as that disclosed in U.S. Pat. No. 6,133,642 to Hutchinson, scales as disclosed in U.S. Pat. No. 6,166,335 to Soehnle, a flashlight as disclosed in U.S. Pat. No. 4,360,860 to Johnson et al., and a battery charger such as disclosed in 5,949,215 to Takakura. In these other devices, kinetic energy is converted into electrical energy. In Soehnle, a linear motion is used, whereas Takakura uses a rotational motion. All of these patents are herein incorporated in their entirety by reference for their teachings of the mechanisms known to generate power, both mechanical and piezoelectric, as well as the circuitry necessary to utilize the power for battery recharging and/or device operation.

However, none of these patents teach or suggest using a self-powering mechanism in association with a wireless device to generate sufficient power to permit at least one call to be made.

### SUMMARY OF THE INVENTION

It is a first object of the present invention to a wireless communication device having a self-powering mechanism.

Another object of the invention is to provide a wireless communication device having a self-powering mechanism, wherein the self-powering mechanism functions in a dual capacity mode, one to generate power, and one to function as part of the operation of the wireless device.

Still another object of the invention is a method of making a phone call on a wireless communication device that is non-functional.

One other object of the invention is the use of a mechanical power generating mechanism or a piezoelectric power generating mechanism in combination with the wireless device.

Yet another object of the invention is a wireless device wherein the keypad cover or antenna is used to generate the power necessary to make a call from the device.

Other objects and advantages of the present invention will become apparent as a description thereof proceeds. In satisfaction of the foregoing objects and advantages, the invention provides improvements in wireless communication devices that employs a device body that houses a rechargeable battery, and includes a keypad, and one of a keypad cover, a battery cover, and a retractable antenna, the device being powered to send and receive signals using the rechargeable battery. In one aspect, the invention provides a power generating mechanism mounted to the device body and having a movable element that is separate from components that contribute to wireless device operation, movement of the element generating electrical energy to allow a user to make at least one call when the battery is discharged.

The power generating mechanism can be a mechanical type that is mounted to the device body and linked to a movable element such as a crank, a lever, the antenna, the battery cover, or the keypad cover. Movement of the crank, the lever, the antenna, the keypad cover or the battery cover can generate electrical energy to allow a user to make at least one call.

In another aspect, the power generating mechanism can be a piezoelectric power generating mechanism. The piezoelectric power generating mechanism can be mounted to the device body and have a movable piezoelectric element. Movement of the element can generate electrical energy to at least send the signal when the battery is discharged, wherein the piezoelectric element is either separate from components that function to operate the wireless device or doubles as a component that functions to operate the device.

In another aspect of the invention, the improvement entails the use of an auxiliary power source and switch for a wireless communication device, either alone or in combination with the self-powered embodiment discussed above.

Yet another aspect of the invention is a wireless communication device that employs an exterior light, wherein the light is illuminated when a call is being received so that a person who is hard of hearing can be prompted to receive the call.

The invention also includes a method of sending a signal using a wireless communication device containing the power generating mechanism described above. By this method, the movable element of the mechanism is operated consistent with its structure, e.g., lever, crank, or cover movement, button or pad depression until sufficient electrical energy is generated to send the signal, and then sending the signal to place the desired call from the communication device.

### BRIEF DESCRIPTION OF THE DRAWINGS

Reference is now made to the drawings of the invention wherein:

FIG. 1 is a side view of one embodiment of the invention;

FIG. 2 is a front view of a wireless device depicting two other embodiments of the invention;

FIG. 3 is a schematic diagram showing the components for generating the power for making or receiving a call;

FIG. 4 is partial view of one embodiment using an antenna as part of the power generating mechanism;

FIG. 5 shows yet another embodiment of the invention; and

FIG. 6 shows an embodiment of the invention employing an auxiliary power source.

### DESCRIPTION OF THE PREFERRED EMBODIMENTS

The present invention offers a significant advancement in the field of wireless communication devices in terms of allowing device operation even when the normal power supply for the phone circuitry is non-functional. The invention allows a user to make a phone call using a wireless communication device by activating a self-powering mechanism. The self-powering mechanism generates sufficient power to allow at least one call to be made in the event of an emergency. By eliminating the total reliance on the wireless communication device's power source, i.e., the battery, the device can still permit at least one call to be made, which otherwise would not be possible.

Referring to FIG. 1, a wireless device 10 is shown having a device body 1, a keypad 3 and a pivoting keypad cover 5. The keypad cover pivots at 7 with respect to the body 1. The device 10 also has an antenna 9, a rechargeable battery 8, and battery cover 8′.

Still referring to FIG. 1, a mechanical power generating mechanism is linked to the keypad cover 5 via pivot 7 such that back-and-forth motion of the cover 5 in the direction “A” generates electrical energy in the same fashion as generated in the prior art patents of Hutchinson, Soehnle, Johnson et al., and Takakura. That is, the cover is linked to a mechanism that drives a generator to generate electrical energy. For example, a pivot pin could extend from the cover and into the device body. Teeth can be positioned around the end of the pivot, or the pivot pin end could have a gear. The gear teeth or teeth on the pin could mesh with another toothed component such as a gear to drive a generator. The driven generator would then produce electrical energy to make the one call.

The advantage of such an arrangement is that the device does not need any other external mechanical appendages to generate the power. Thus, from the observer's standpoint, the wireless device looks like a typical device. The actual mechanism can be any type that would convert the repeated rotational energy of the moving keypad cover into electrical energy such as the devices disclosed in Hutchinson, Soehnle, Johnson et al., and Takakura. It should be understood that the invention in this embodiment is the use of an existing component of the wireless device to generate the needed power to make the phone call.

An alternative embodiment could use the antenna 9′ of the device 10′ of FIG. 2. In this embodiment, the antenna 9′ moves linearly with respect to the body 1′ as does the tappet of Soehnle to generate power. The antenna 9′ could be linked to a generator/dynamo with a rack and pinion arrangement as is used in Soehnle and discussed in more detail below. Of course, other mechanisms could also be employed to convert the linear motion of the antenna into electrical energy as are known in the art.

Referring still to FIG. 2, another mode of the invention is disclosed wherein the wireless device incorporates an additional power generation mechanism that does not relate to device operation. In this mode, a lever 11 can be provided in the device body 1′, wherein the lever would be depressed one time or repeatedly to drive a generator or the like to generate electrical power. The number of repetitions is based on the power generating mechanism, wherein only one depression may generate sufficient power. However, more than one depression may be required. In either event, it is not the number of repetitions that is critical but the ability to easily generate power if the device battery is discharged.

FIG. 3 shows a schematic which identifies the components of the invention in a generic manner rather than specific mechanisms or circuitry. Reference numeral 20 represents the motion generating mechanism, whether it be the antenna, the keypad cover, the lever, a button, or even a rotating crank. The mechanism 20 may include the rack and pinion arrangement as noted above, or a gear arrangement described above for partial rotation of the keypad, or even complete rotation of a crank.

Also shown is the mechanism 21 which represent the mechanism that converts the kinetic energy into electrical energy. This mechanism can include a dynamo/generator as well as any other known electrical components that are commonly employed in self powered devices, e.g., capacitors, voltage regulators, switches, etc. It should be understood that the actual components used to convert the kinetic energy into electrical energy are disclosed in the prior art, and are made a part of this application by incorporation of the Hutchinson, Johnson et al, Takakura, and Soehnle patents. One skilled in the art would readily be able to identify the necessary electrical components to supply the requisite power to the device circuitry 23 of the wireless device to be able to send a call, and a more detailed description is not necessary for understanding of the invention. For example, the Hutchinson patent teaches how a radio is powered by a mechanical power generating device and discloses the necessary circuitry to ensure that the proper voltage is generated to operate the radio. Likewise, the power generating mechanism 21 is designed to generate the requisite power to at least transmit a signal from the wireless device, and preferably generate enough power to also receive a signal.

FIG. 3 also illustrates the embodiment wherein the power generating can either recharge the battery 8 for device operation or merely supply power to send a signal directly via a capacitor or the like. Battery recharging in combination with mechanical power generation is described in Johnson et al. and a further description of the details of such recharging are not deemed necessary for understanding of the invention. It should be understood that a key feature of the invention is the generation of power to send at least one signal using the wireless communication device, and the power may be stored in a capacitor prior to its use, used to recharge a battery prior to its use, or any other technique which will allow the power to be used to send the signal via the wireless communication device.

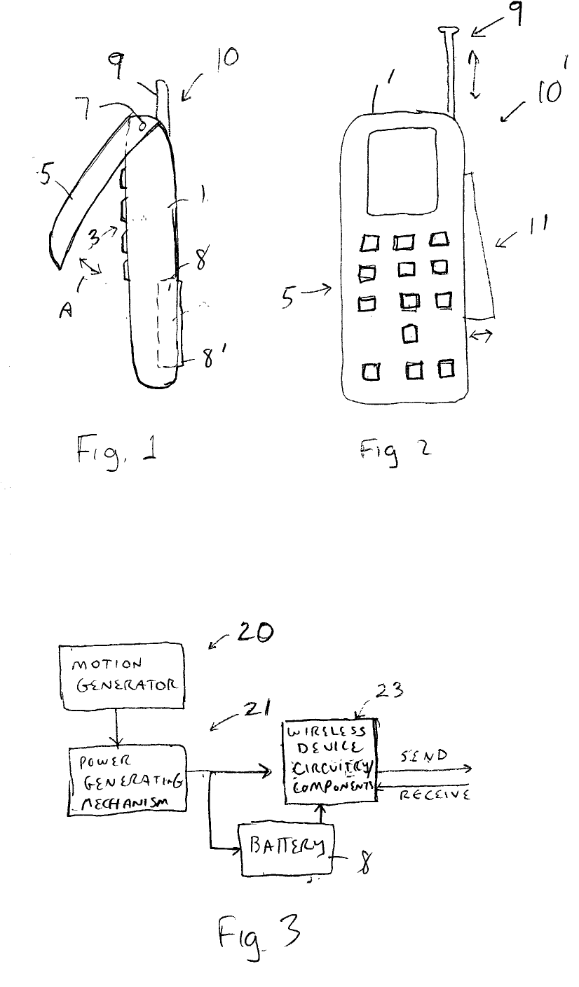

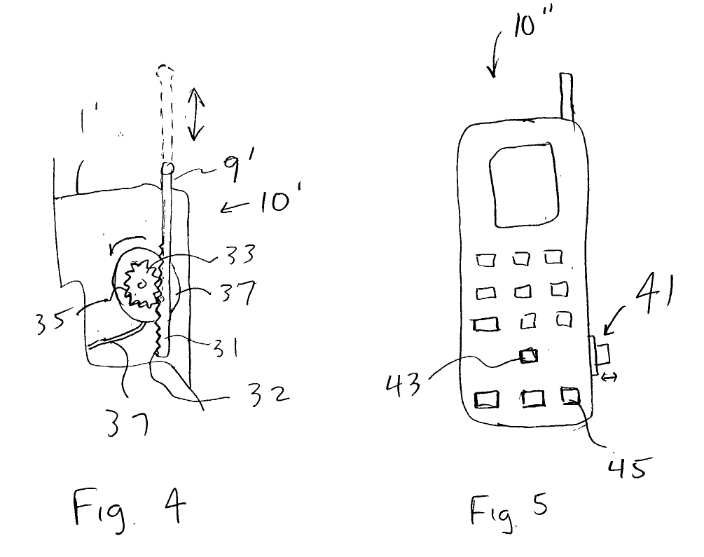

FIG. 4 shows a specific example of the power generating mechanism 20. One end of the antenna 9′ is equipped with a rack 31. The teeth 32 of the rack 31 mesh with teeth 33 of the gear 35. The antenna is mounted with respect to the device body for linear movement. The gear 35 is linked to a generator 37, whereby linear movement of the rack 31 rotates the gear 35 and generator 37 to supply power via the generator 37 for wireless device operation. The gear 35 and generator 37 are also mounted to the device body for movement about the gear/generator axis.

FIG. 5 shows yet another embodiment wherein the wireless device 10′ uses a piezoelectric power generating mechanism. The button 41 is depressed to generate power in a similar fashion as the keyboard element of Henty. Since it is known to generate power using piezoelectric elements in this fashion, a description of the circuitry is not deemed necessary for understanding of the invention. The power generated by the Henty device to recharge a laptop battery is believed to be sufficient to provide sufficient power to at least make one call on the wireless device. As noted above, the power generation mechanism of FIG. 5 is one example, but the invention is not so limited. While a separate button 41 is illustrated, one of the numeric keypads 43 could be used, or another keypad such as a menu keypad 45 could also be employed for power generation.

Typically, the rechargeable batteries in wireless devices are rated at 3-4 volts and 300-800 milliamps, and the mechanical power generator should easily supply this type of power. For example, the generator of Johnson et al. is designed to supply 6.0 amperes at about 3 volts in order to power the flashlight bulb rated at 0.3 amperes at 2.47 volts for 10 minutes. Since far less than 10 minutes would be needed in an emergency situation with a wireless device to make a call, much less power needs to be generated for making one wireless call, and the mechanism would not have to be as cumbersome as that disclosed in Johnson et al.

While conventional cell phones are shown as typical wireless devices, it is believed that any wireless device capable of sending/receiving a signal, e.g., a palm pilot or the like, could also be used.

As noted above, the invention is useful when a wireless communication device becomes non-functional because of a discharged battery. Other examples include ones where the battery may be missing. Further yet, the battery may be charged, but the battery circuitry and/or wiring supplying the device circuitry with power from the battery may be faulty. Circuitry that would bypass the battery and be used for sending a call would also avoid this signal transmission problem.

As noted above, the invention involves a first set of power generating mechanisms that function in a dual capacity in that they operate as part of the wireless device. These include keypad covers, antenna, battery covers which can be pivoted back and forth or moved linearly just like the keypads or antennas, buttons, including those on the keypad, and others such as on-off buttons, etc. These generating devices could be mechanical such as those associated with the keypad cover or antenna, or piezoelectric such as keypad buttons or the like.

Alternatively, a second set of power generating mechanisms could be provided which are independent of those components that function to operate the wireless device. For example, a separate crank or lever could be provided whose sole function is to provide the necessary energy to send a signal or recharge the battery. Likewise, a separate piezoelectric element could be employed whose sole function is to provide power when the battery is discharged. However, it is preferred that the power generating mechanism is one that has a dual capacity. In this instance, it is only necessary to supply the mechanism with the components to translate the motion to the power generator, and it is not necessary to supply an additional component that must be worked by a user, i.e., a separate crank or lever.

The inventive method entails sending at least one signal by generating power using the power generating device instead of using the battery/battery circuitry of the device. Only sufficient power is needed to make at least one call so that the user of the wireless device is capable of notifying someone as to location or situation. Of course, one could continue to generate power to make more than one call if need be. In fact, if possible, the power generating mechanism could be worked during the call to maintain power for signal sending.

While device components such as antennas, keypad, battery covers are selected as items for generating power, any other item that functions in part in the operation of the device can be used in conjunction with the invention. For example, the device may have a cover for accessing the activation chip. Anything that would normally be part of the device can be used to generate power if capable of being moved between at least two positions.

Another aspect of the invention involves the use of an auxiliary power source such as a spare rechargeable battery and a switch or other component that must be activated before the auxiliary power source can be used to send or receive a signal.

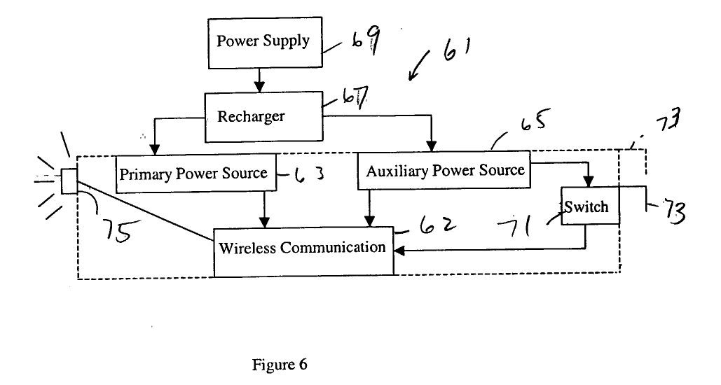

Referring to FIG. 6, a schematic diagram shows a typical arrangement for a wireless communication device designated by the reference numeral 61. A wireless communication circuitry is represented by 62. The device 61 contains a primary power source 63 such as a rechargeable battery, and an auxiliary power source 65, also capable of being a rechargeable battery. The auxiliary power source 65 can be housed in the device 61 in the same manner the primary power source is housed, e.g., within a cavity in the housing and retained by a cover or the like. In other instances, the battery can be secured without a cover. Other variations as would be within the skill of the art in terms of mounting the auxiliary power source in the device 61 can also be employed.

Each of the power sources 63 and 65 is capable of being recharged via the recharger 67 and power supply 69.

The device 60 also has a switch 71 that is activated or turned on before the auxiliary power source can be used to power the device. The switch 71 can be a toggle, a button, or any other type of component that can be operated by a user when the primary power source becomes discharged. It is preferred that the switch be located on the phone where it would not be accidentally turned on by a user. For example, the switch could be located away from all other pads or switches on the phone. Further yet, the switch could have a cover 73 that could slide as shown, or move in some other way to expose the switch for operation. A cover such as this would deter accidental switching when the primary power source is still charged. Alternatively, if the switch is on, and the primary power source is still charged, an indicator could be employed to alert the user that the switch is in the on position for the auxiliary power source so the user can turn it off.

The presence of the switch 71 acts as a fail-safe mechanism to allow the auxiliary power source to maintain its charge, and not be drained once the primary power source discharges. If the switch was not there, the auxiliary power source could be used once the primary power source is discharged. In this situation, a user would not necessarily know that the auxiliary power source is being used, and once this power source is discharged, the user would be left with a completely discharged communication device. The switch requires the user to physically activate the auxiliary power source once the primary power source is discharged so that a call can still be made.

The auxiliary power source can be a fraction of the size of the primary power source since it only needs to have enough power to allow at least one call to be made. Of course, the auxiliary power source could be sized to allow for a number of calls to be made. An indicator could be provided to tell the user the extent of the power in the auxiliary power source as is done now with primary power sources.

In yet another embodiment, the auxiliary power source could be a long-life battery such as a lithium battery or the like so that it does not have to be part of the recharging circuitry. In this instance, the wireless communication device could have an indicator to instruct a user that the long life battery needs to be replaced.

It should be understood that the embodiment depicted in FIG. 6 could be combined with the power generating embodiments of the invention as shown in FIGS. 1-5. That is, a wireless communication device could be equipped with both the auxiliary power source invention as well as the power generating mechanism. In this mode, even if the auxiliary power source would discharge, a user could still rely on the power generating mechanism to make a call from the wireless communication device.

The wireless communication device of FIG. 6 is an improvement in known wireless devices that have rechargeable batteries. The inventive device includes an auxiliary power source, which may be a rechargeable battery or merely a lithium or alkaline battery or the like. The device also includes a means to activate the auxiliary power source such as a switch or other component. This switch requires the user to make a conscious effort to use the auxiliary power source, and is an ideal way to allow the user to make a call or receive a call once the primary power source is discharged.

A further embodiment of the invention includes the use of a lighting device 75 on the exterior of the device 60. This light is designed to alert people who are hard of hearing that a call is being received on the wireless device. The light can be any type but it is preferred that the light is a flashing type such as a strobe light to better attract a person's attention that a call is being received. The light 75 is powered by the primary power source via the device 61 when a call is being received. The lighting device 75 can be activated by the user through the appropriate controls of the wireless device keypad or the like, or even a separate switching arrangement.

As such, an invention has been disclosed in terms of preferred embodiments thereof which fulfills each and every one of the objects of the present invention as set forth above and provides new and improved wireless communication device that can be operated with a discharged battery and a method of use.

Of course, various changes, modifications and alterations from the teachings of the present invention may be contemplated by those skilled in the art without departing from the intended spirit and scope thereof. It is intended that the present invention only be limited by the terms of the appended claims.

What is claimed is:

1. In a wireless communication device having device body that houses a rechargeable battery, and includes a keypad, and one of a keypad cover, a battery cover, and a retractable antenna, the device being powered to send and receive signals using the rechargeable battery, the improvement comprising a mechanical power generating mechanism mounted to the device body and linked to one of the antenna, the battery cover, or the keypad cover such that movement of the antenna or keypad cover or a battery cover generates electrical energy to allow a user to make at least one call.

2. In a wireless communication device having device body housing a rechargeable battery, and containing a keypad, and an antenna, the device being powered to send and receive signals using the rechargeable battery, the improvement comprising a power generating mechanism mounted to the device body and having a movable element that is separate from components that contribute to wireless device operation, movement of the element generating electrical energy to allow a user to make at least one call when the battery is discharged.

3. The device of claim 2 wherein the device is either a mechanical power generating mechanism or a piezoelectric power generating mechanism.

4. The device of claim 2, wherein the mechanical power generating mechanism is one of a lever or crank, at least partial rotation thereof generating the electrical energy.

5. The device of claim 2, wherein the piezoelectric generating mechanism is a piezoelectric element mounted to the device body, one or more depressions of the element generating the electrical energy.

6. In a wireless communication device having device body housing a rechargeable battery, and containing a keypad, and an antenna, the device being powered to send and receive signals using the rechargeable battery, the improvement comprising a piezoelectric power generating mechanism mounted to the device body and having a movable piezoelectric element, movement of the element generating electrical energy to at least send the signal when the battery is discharged, wherein the piezoelectric element is either separate from components that function to operate the wireless device or doubles as a component that functions to operate the device.

7. A method of sending a signal using a wireless communication device comprising providing a device according to claim 1, and moving the keypad cover, the battery cover, or the antenna until sufficient electrical energy is generated to send the signal, and sending the signal.

8. A method of sending a signal using a wireless communication device comprising providing a device according to claim 2, and moving the element to generate electrical energy, and then sending the signal.

9. A method of sending a signal using a wireless communication device comprising providing a device according to claim 6, and moving the element to generate electrical energy, and then sending the signal.

10. The device of claim 6, wherein a piezoelectric element is a button mounted on the device body or an operative keypad of the device.

11. The device of claim 1, further comprising an auxiliary power source and a switch to activate the auxiliary power source when the primary power source is discharged.

12. The device of claim 1, further comprising a light mounted on the wireless communication device, the light designed to illuminate when a call is being received.

13. The device of claim 2, further comprising an auxiliary power source and a switch to activate the auxiliary power source when the primary power source is discharged.

14. The device of claim 2, further comprising a light mounted on the wireless communication device, the light designed to illuminate when a call is being received.

15. The device of claim 6, further comprising an auxiliary power source and a switch to activate the auxiliary power source when the primary power source is discharged.

16. The device of claim 6, further comprising a light mounted on the wireless communication device, the light designed to illuminate when a call is being received.

17. In a wireless communication device having device body that houses a rechargeable battery, the device being powered to send and receive signals using the rechargeable battery, the improvement comprising an auxiliary power source and a switch to activate the auxiliary power source when the primary power source is discharged, or a wireless device without the power generating mechanism and just the auxiliary power source and switch.

18. The device of claim 17, further comprising a light mounted on the wireless communication device, the light designed to illuminate when a call is being received.
